(19) United States
(12) Patent Application Publication
(10) Pub. No.: US 2007/0026191 A1
(43) Pub. Date: Feb. 1, 2007

(54) Vibration welding element for thermoplastic members

(76) Inventor: Stephen Field, Ottawa (CA)

Correspondence Address: WENDEROTH, LIND & PONACK, L.L.P., 2033 K STREET N. W., SUITE 800, WASHINGTON, DC, 20006-1021, US

(21) Appl. No.: 11/488,767

(22) Filed: Jul. 19, 2006

Related U.S. Application Data
(63) Continuation-in-part of application No. 10/473,677, filed on Sep. 30, 2003, now Pat. No. 7,122,088.

(30) Foreign Application Priority Data
Jun. 7, 2001 (CA) 2,349,795

(51) Int. Cl. B29C 65/06; B32B 37/00; B32B 3/10; B32B 7/00

(52) U.S. Cl. 428/119; 156/73.5; 156/580; 428/131

(57) ABSTRACT

A vibration welding element for thermoplastic members, and related joint structures, assemblies, and methods, are disclosed. A vibration welding element that is composed at least in part of a thermoplastic material includes at least one welding surface for forming a vibratory welded bond with at least one thermoplastic member. The element also includes a component holder that is physically coupled to the welding surface for enabling the element to hold a further component. The component holder may also be held in a fixture of a vibratory head during a vibratory welding process by which a vibratory welded bond is formed.

### CROSS-REFERENCE TO RELATED APPLICATIONS

This application claims the benefit of U.S. patent application Ser. No. 10/473,677, and is a continuation-in-part thereof. U.S. patent application Ser. No. 10/473,677 was filed on Sep. 30, 2003 as a National Phase application of PCT/CA02/00842, which was filed on Jun. 7, 2002 claiming priority from Canadian Patent Application Serial Number 2,349,795, filed on Jun. 7, 2001.

### FIELD OF INVENTION

This invention relates generally to vibration welding of thermoplastic members and more particularly to vibration welding of thermoplastic members using a separate element.

### BACKGROUND

There are some limitations with existing methods of vibration welding thermoplastic members using a separate element, as generally these separate elements are used only to form a weld between thermoplastic members and do not serve any other purpose.

Thus, there remains a need for improved vibration welding methods and joint structures using a separate element.

### SUMMARY

According to an aspect of the invention, there is provided a vibration welding element composed at least in part of a thermoplastic material, said element comprising a welding surface for forming a vibratory welded bond between said element and a thermoplastic member, and a component holder, physically coupled to said welding surface, for enabling said element to hold a further component.

The component holder may comprise a tab that further enables said element to be held in a fixture of a vibratory head during a vibratory welding process by which said vibratory welded bond is formed.

The component holder may comprise a cavity, defined at least partially by said welding surface, for receiving at least a portion of said further component.

In some embodiments, the component holder comprises a structure for receiving a fastener, said structure allowing said further component to be secured to said element by a fastener inserted into said structure.

The further component may be integrated with the element, said component holder comprising a portion of said element connecting said welding surface with said further component.

The component holder may be integrated with an extension of said element beyond said welding surface. The extension may comprise, as said component holder, at least one of: a cavity for receiving at least a portion of said further component, and a structure for receiving a fastener, said structure allowing said further component to be secured to said element by a fastener inserted into said structure. The extension may be at an angle to said welding surface.

In some embodiments, said extension extends in a direction parallel to said welding surface and comprises an end structure, and said further component comprises a structural support incorporating at least one opening having a shape complementary to said end structure, said end structure enabling said element and said member to be supported by said structural support. The end structure may further enable said element to be held in a fixture of a vibratory head during a vibratory welding process by which said vibratory welded bond is formed. The structural support may include a multi-sided structural support, a plurality of sides of said structural support incorporating respective openings having a shape complementary to said end structure. The structural support may also or instead include a connector incorporating at least two adjacent, spaced openings having a shape complementary to said end structure.

An extension of the element may be substantially perpendicular to said welding surface and have substantially the same cross sectional shape as said thermoplastic member. The component holder may include means for attaching said further component. The means for attaching said further component may include a hole and/or a protrusion, for example.

In one embodiment, the component holder includes one or more edges of said welding element, and said further component includes a flexible rubber seal.

The component may include at least one of: a fixed structural support, a component of a movable hardware arrangement, a compressible seal, and an adjustable leg.

According to another aspect of the invention, a joint structure includes first and second thermoplastic members, and an interposed junction piece comprising welding surfaces respectively vibratory welded to said first member and to said second member, and a component holder, physically coupled to said welding surfaces, for enabling said joint structure to hold a further component.

The welding surfaces may be parallel to each other, in which case the component holder may include an extension of said junction piece perpendicular to the welding surfaces, with said interposed junction piece forming a butt joint between said members.

Where the welding surfaces are parallel to each other, said interposed junction piece may form a miter joint between said members, and said component holder may include an extension of said interposed junction piece at an angle to said welding surfaces and perpendicular to one of said members.

The extension may incorporate a connector, which in some embodiments includes a plate having a preformed hole therein.

The component holder may include an extension of said interposed junction piece beyond said welding surfaces, said extension spacing a connector from one of said members and positioning said connector parallel to a longitudinal length of said one of said members.

The connector may include an open-ended slot connector.

In some embodiments, the component includes at least one compressible seal for sealing a gap between said first and second members.

An assembly may incorporate a plurality of such welded joint structures

A method for forming a vibratory welded connection between a welding element and a structural member, the member and the junction piece being composed at least in part of thermoplastic material, is also provided. The method includes providing a welding element having a welding portion for welding to said member, and a component holder, physically coupled to said welding portion, for enabling said element to hold a further component; creating an engagement force between said member and said welding portion; and maintaining said engagement force while vibrating said welding element to create friction generated heat to melt material on said welding portion and said member, such melted material upon cooling forming a weld between said welding element and said member.

The operation of vibrating may involve mounting said component holder to a fixture connected to a vibratory head, and vibrating said welding element by means of said vibratory head.

The method may also include installing said further component at said component holder.

In some embodiments, the welding element comprises a removable tab that is held in a fixture during vibration of the welding element, and wherein said welding portion is offset from said removable tab.

### BRIEF DESCRIPTION OF THE DRAWINGS

FIG. 1-a shows an exploded perspective butt joint detail of two elongated thermoplastic members that are vibration welded together using a separate corner element that incorporates a hollow cavity for holding a further component.

FIG. 1-b shows a side elevation view detail of the vibration welded corner butt joint assembly shown in FIG. 1-a.

FIG. 2-a shows a perspective detail of a vibration welded corner butt joint incorporating a corner element with a hollow side edge extension as a component holder.

FIG. 2-b shows a front edge elevation view of the corner element as shown in FIG. 2-a.

FIG. 2-c shows a side face elevation view of the corner element as shown in FIG. 2-a.

FIG. 3-a shows a perspective detail of a vibration welded corner butt joint incorporating a corner element with a perpendicular back edge extension as a component holder.

FIG. 3-b shows a side elevation view of the corner butt joint shown in FIG. 3-a.

FIG. 4 shows a perspective detail of a vibration-welded corner butt joint incorporating a corner element with a side edge extension as a component holder that is attachable to a fixed support.

FIG. 5-a shows a perspective detail of a vibration welded corner butt joint incorporating a corner element with perpendicular holes in a side edge as a component holder.

FIG. 5-b shows a side elevation of the corner butt joint detail shown in FIG. 5-a.

FIG. 5-c shows a back elevation of the corner butt joint detail shown in FIG. 5-a.

FIG. 6-a shows a partially exploded perspective detail of a vibration welded corner butt joint incorporating a corner element with a side edge extension as a component holder that is attachable to an operable hardware component.

FIG. 6-b shows a partially exploded plan view of the perspective butt joint detail shown in FIG. 6-a.

FIG. 7-a shows a partially exploded perspective detail of a vibration welded corner butt joint incorporating a corner element with a side edge extension and T-shaped end structure that allows for a box panel assembly to be constructed.

FIG. 7-b shows a partially exploded cross section corner plan detail of a box panel assembly featuring vibration welded butt joints as shown in FIG. 7-a.

FIG. 7-c shows a perspective view of a box panel assembly fabricated using the corner detail shown in FIG. 7-b.

FIG. 8-a shows an elevation view of framed panel wall assembly.

FIG. 8-b shows a horizontal cross section detail of the framed panel wall assembly shown in FIG. 8-a.

FIG. 9-a shows a perspective detail of a vibration welded corner miter joint incorporating a separate corner junction piece with an inclined angle back edge extension as a component holder.

FIG. 9-b shows a partially exploded elevation detail of the welded miter joint shown in FIG. 9-a.

FIG. 10-a shows a perspective detail of a vibration welded miter corner joint incorporating a corner element with a side extension including a parallel leg for panel attachment.

FIG. 10-b shows a partially exploded elevation corner detail of a panel attachment as shown in FIG. 10-a.

FIG. 11-a shows a perspective detail of a vibration welded joint assembly incorporating a welding element with flexible seals on top and bottom side edges.

FIG. 11-b shows a perspective detail of the welding element as shown in FIG. 11-a.

FIG. 12-a shows an exploded perspective detail of a thermoplastic U-channel member and with a vibration welding element incorporating a threaded hole.

FIG. 12-b shows a perspective detail of the threaded hole element vibration welded to the U-channel member shown in FIG. 12-a.

FIG. 12-c shows a front elevation detail of the vibration welded joint shown in FIG. 12-b.

FIG. 12-d shows a perspective detail view of the vibration welded joint shown in FIG. 12-b with an adjustable leg support inserted into the threaded hole element.

FIG. 12-e shows an exploded perspective detail of a hollow thermoplastic member with a threaded hole vibration welding element and an adjustable leg support.

FIG. 12-f shows a perspective view of the final assembled components as shown in FIG. 12-e.

FIG. 13-a shows a partially exploded perspective detail of a vibration welded corner butt joint incorporating a separate welding element featuring a dual function back edge extension.

FIG. 13-b shows a perspective detail of a vibration welded corner butt joint as shown in FIG. 13-a.

FIG. 13-c shows an elevation view of a panel assembly formed using joints as shown in FIG. 13-b.

FIG. 14-a shows an exploded perspective detail of a vibration welded corner butt joint incorporating a separate welding element featuring a dual function, bottom held, back edge extension.

FIG. 14-b shows a perspective view of the vibration welded corner butt joint shown in FIG. 14-a.

FIGS. 15-a and 15-b are plan views of an example of vibration welding equipment that may be used to fabricate a corner butt joint incorporating a component holder.

### DETAILED DESCRIPTION OF DRAWINGS

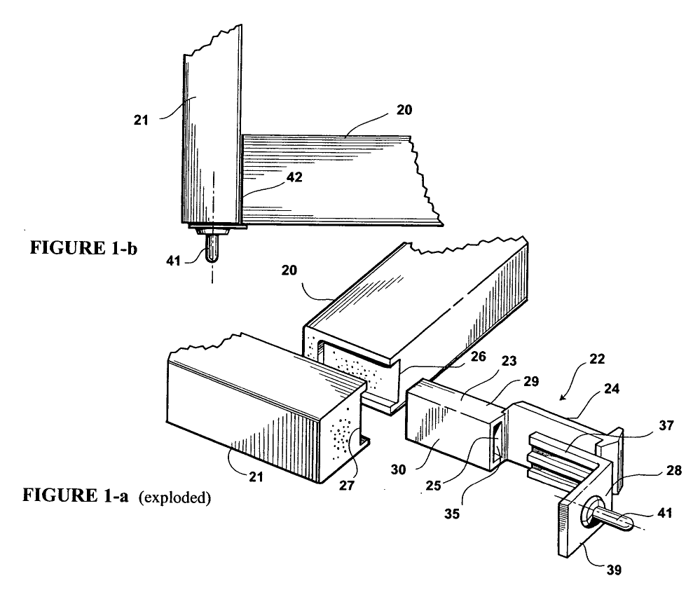

FIG. 1-a shows an exploded perspective detail of a corner joint of two thermoplastic member 20 and 21 that are vibration welded together using a thermoplastic welding element or interposed junction piece 22. The welding element 22 is made from a thermoplastic material that has a similar melt temperature to the thermoplastic members 20 and 21. As shown in Figure 1A, the thermoplastic members are made from foam material. Alternatively, the members can also or instead be made from solid or hollow profile thermoplastic material.

The thermoplastic welding element 22 includes a first portion 23 that is welded to the thermoplastic members 20 and 21 and a second portion or tab 24 that is firmly held in the vibration welding clamping fixture (not shown). During the vibration welding process, perpendicular pressure is applied to both sides 29 and 30 of the welding element and the element 22 is vibrated back and forth very rapidly, illustratively at a rate of 175 to 225 Hz, creating friction that melts the adjacent thermoplastic surfaces thereby forming vibratory welded bonds between the two side surfaces 29 and 30 of the welding element 22 and the two thermoplastic members 20 and 21.

To allow for a further hardware component such as an attachment device to be installed following the welding process, the first portion 23 of the welding element 22 incorporates a component holder 25 that is integrated with and physically coupled to the welding element 22. As shown in FIG. 1-a, the component holder 25 includes a single longitudinal hollow cavity 35 located on the back edge of the first portion 23 of the welding element 22. More generally, instead of including a single cavity, the component holder can include multiple cavities and/or other structures such as one or more holes, indents, voids etc. The hollow cavity 35 can also have any cross sectional shape and can be centered or off-centered in the welding element.

To accommodate an extended overall width of the welding element 22, channel recesses 26 and 27 are formed in the side and end surfaces of the first and second members 20 and 21. The side welding surfaces 29 and 30 of the first portion 23 of the welding element 22 are welded to channel recesses 26 and 27 formed in the end face of the first member 20 and the side face of the second member 21. The side edges of the welding element 22 may also be partially bonded to the side edge surfaces of the channel recesses due to flash flow and limited pressure contact during the friction welding process. As a result, the component holder 25 is firmly held in position at the junction of the thermoplastic members 20 and 21. In addition, the hollow construction and extended overall width of the first portion 23 of the welded element 23 also provides for increased stiffness and rigidity and this allows the welding element 22 to handle the high forces that are experienced during the vibration welding process.

After the vibration welding process is complete, the second portion or tab 24 is removed and this provides clearance so that there is no obstruction when inserting a further component 28 into the component holder 25. This further component 28 can be made from a variety of materials, including but not limited to metals such as aluminum, steel, brass, and/or nickel, and plastics such as thermoplastics, thermosets, and/or composites. The further component 28 incorporates a centering element 37 and in some embodiments, the component holder 25 incorporates complementary centering means (not shown) that allow the further component 28 to be accurately positioned and held within the component holder 25. In addition, the further component 28 can be connected to the component holder 25 through pressure fit attachments, adhesives, sealants and/or other bonding systems.

The further component 28 can also incorporate various hardware features such as a pivot attachment 41 that can support and connect a frame assembly constructed from one or joints as shown in FIG. 1-a to an outer assembly (not shown). The pivot attachment 41 can be centered on the second member 21 or offset in multiple directions to allow the further component 28 to carry out various other positioning and fastening functions. The hardware component 28 can also incorporate a cover or cap 39 that can protect the exposed end surface of the thermoplastic member 21. This may be particularly useful for composite thermoplastic materials that can be damaged by moisture or other environmental conditions, such as wood fiber filled Polyvinyl Chloride (PVC) materials.

Due to the large, dynamic structural loads and moments involved with conventional window hardware systems, a pivot attachment is typically fixed and anchored to a hollow or solid profile thermoplastic member using metal screws or other fastening systems. In comparison, thermoplastic foam materials are generally quite soft and so these materials typically cannot easily hold conventional screws and fastening systems in position. However by using an intermediary thermoplastic junction piece 22, these attachment problems with foam materials can be overcome. First, the point load from the pivot attachment 41 is spread out and supported by the larger area of the thermoplastic welding element 22 and second, the structural load and moment imposed by the welding element is also spread out over a larger area of foam material. The hollow structure of the junction piece 22 also helps resist the torsional loads applied by the hardware attachment. Since the welding element 22 is sandwiched between thermoplastic members 20 and 21, these loads are effectively transferred to and resisted by the entire welded corner junction assembly.

FIG. 1-b shows a side elevation view detail of the vibration welded corner butt joint assembly as shown in FIG. 1-a. Because the thermoplastic members 20 and 21 overlap the vibration junction piece 22, a thin line butt joint 42 is created.

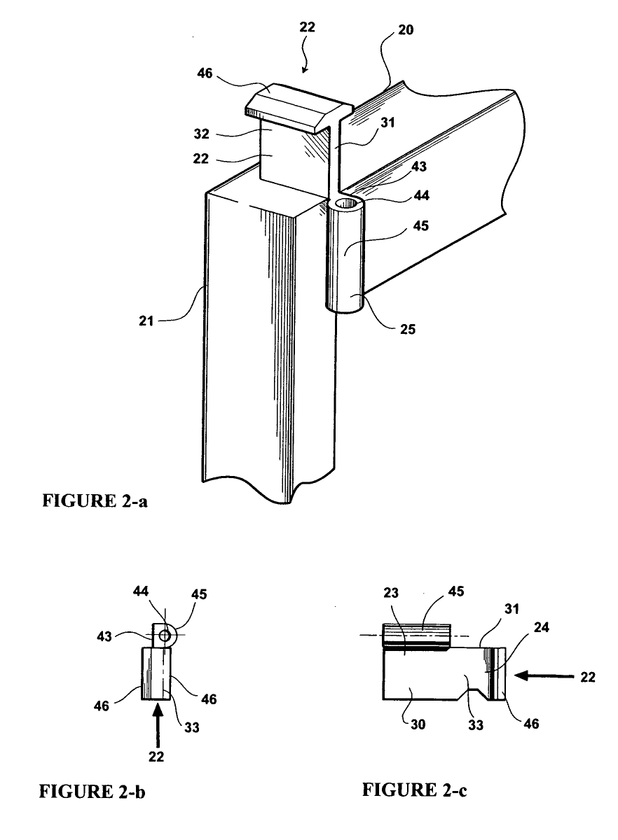

FIG. 2-a shows a perspective detail of a vibration welded corner butt joint that is similar to the vibration welded joint shown in FIG. 1-a but with an alternative configuration of the component holder 25. In this case, the component holder 25 includes a side extension 43 that is located on the inner side edge 31 of the junction piece 22. The side extension 43 incorporates a longitudinal hollow cavity 44 that creates a tubular extension or hinge barrel 45.

A further pivot attachment component or hinge pin (not shown) can be inserted into the hollow cavity 44 and this attachment component can support an operable frame assembly such as a window or door. To prevent long term wear, a metal or plastic sleeve can be inserted into the tubular extension 45. Alternatively, the tubular extension 45 can incorporate an integral inner thermoplastic liner made from a harder grade of thermoplastic material. Where the junction piece 22 is fabricated using an injection molding process, an option of a dual shot process may be employed for fabricating double material components if similar bondable materials are used.

The side extension 43 can be incorporated on the inside 31 or outside side edge 32 of the welding element 22. The side extension 43 is not necessarily hollow or tubular and can feature various cross sectional shapes as well as being made from solid material with conventional screw attachment to the other hardware component. The side extension 43 can also be off centered from the junction piece, as shown, to allow for the pivot point of the frame assembly to be changed.

The side extension 43 is also not necessarily a single hollow cavity and can for example consist of two separate hinge barrels interlocking with a similar element and then held in position by inserting a pin connector.

Although the component holder 25 in shown in FIG. 2-a is a hollow cavity, the component holder can also or instead include a protrusion, with the other component including a complementary hollow device.

FIG. 2-b shows a front edge elevation view of the thermoplastic welding element 22 as shown in FIG. 2-a. The thermoplastic junction piece 22 includes a front edge 33 and a side extension 43 incorporating a hollow cavity 44. To hold the junction piece 22 firmly in position during the vibration welding process, the junction piece 22 incorporates a T-shaped end structure 46.

FIG. 2-c shows a side face elevation view of the thermoplastic welding element 22 as shown in FIG. 2-a. The thermoplastic welding element 22 incorporates a side face 30, with a tubular extension 45 incorporated on the side edge 31 of the welding element 22. The tubular extension 45 is only incorporated on the first portion 23 of the welding element 22, as the second portion 24 of the welding element may be removed after the vibration welding process is completed.

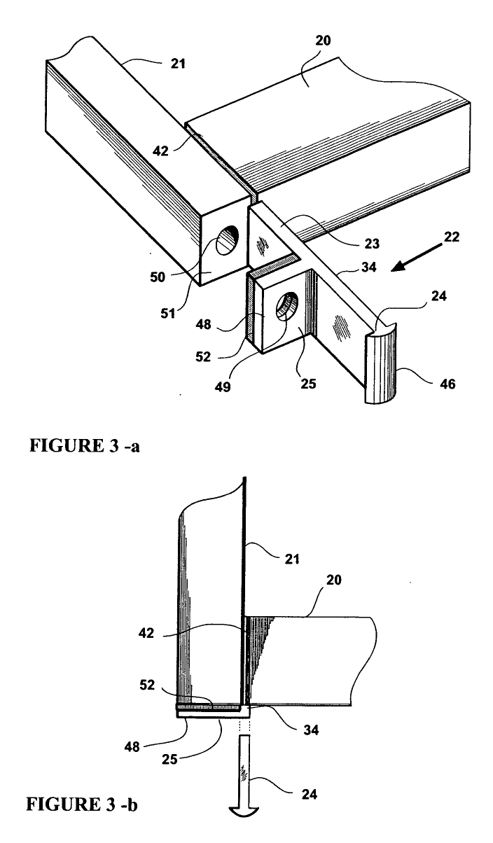

FIG. 3-a shows a partially exploded perspective detail of a vibration welded corner butt joint that is also similar to the vibration welded joint shown in FIG. 1-a but with a further alternative configuration of the component holder 25. In this case, the component holder 25 is a hole 49 incorporated into a perpendicular extension 48 to the back edge 34 of the first portion 23 of the welding element 22.

The hole 49 allows for the insertion of various hardware attachment devices (not shown) and a complimentary hole 50 may thus be fabricated in the end face 51 of the thermoplastic member 21, as this allows for a protrusion attachment device to be more firmly supported.

The perpendicular back edge extension 48 has the same shape as the end face 51 of the thermoplastic member 21 in the embodiment shown in FIG. 3-a. To prevent damage of the exposed end face thermoplastic material of the member 21, compressible material 52 is laminated to the back face of the perpendicular back edge extension 48. Following the fabrication of a friction welding corner joint, sufficient pressure can be maintained on the compressible material so that the end face 51 of the thermoplastic member 21 is effectively sealed.

FIG. 3-b shows a side elevation view of the completed vibration welded corner butt joint as shown in FIG. 3-a. The perpendicular back edge extension 48 of the welding element 22 covers the end face 51 of the thermoplastic member 21 and the compressed flexible foam 52 prevents moisture and/or other environmental conditions from damaging the thermoplastic end face material. The second portion 24 of the junction piece 22 is removed, providing for a clean visual finish appearance.

Similar to the component holder shown in FIGS. 2-a and 2-b, the component holder shown in FIG. 3-a can be male or female. In the case of a male configuration, a profile cap, represented in FIG. 3-a as the back edge extension 48, may incorporate some form of protrusion that can be inserted into a hollow attachment device. This protrusion may be an integral part of the junction piece or may be a screw or bolt, for example, that is attached to the perpendicular back edge extension 48.

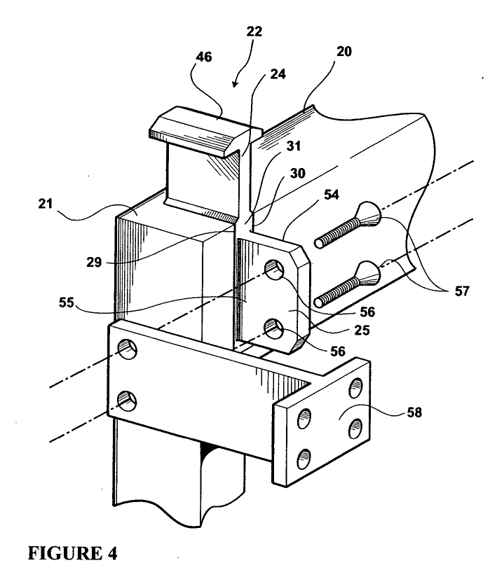

FIG. 4 shows a perspective detail of a vibration welded corner butt joint that is also similar to the vibration welded joint shown in FIG. 1-a but with a further alternative configuration of the component holder 25. In this case, the component holder 25 is a side edge extension 54 that incorporates holes 56 in the side face 55 of the extension 54. These holes 56 allow for a frame assembly (partially shown) that is constructed using welded joint structures to be secured by screws, bolts, or other fasteners 57 to a further fixed attachment component 58.

As shown in FIG. 4, the further attachment component 58 is a T-shaped bracket support. Alternatively, instead of using a fixed rigid support, the further attachment component can be a flexible wire or other movable component, with the frame assembly being then attached to a further attachment such as a hook or similar support.

FIG. 4 also shows the side edge extension 54 as being attached to the further attachment component 58 using fasteners 57 such as screws or bolts. To provide for improved assembly and support, the side edge extension 54 can incorporate thread inserts as part of the welding element 22. In other embodiments, instead of using screws or bolts, other fastening systems can be used, including rivets, pins, ultrasonic pegs, etc.

As shown in FIG. 4, the side edge extension 54 is a single solid wall. Alternatively, the side extension 54 can be a double wall assembly with the further attachment component 58 being sandwiched between the two walls.

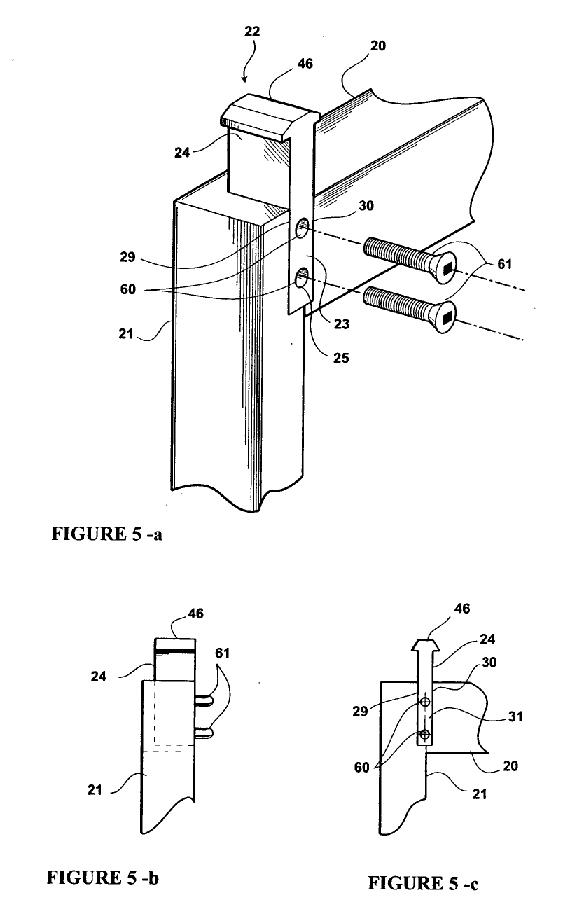

FIG. 5-a shows a partially exploded perspective detail of a vibration welded butt joint that is also similar to the vibration welded joint shown in FIG. 1-a but with a further alternative configuration of the component holder 25. In this case, the component holder 25 includes one or more holes 60 that are incorporated into the side edge of the welding element 22 and may be perpendicular to the side edge. Connectors 61, which are rigid connectors in some embodiments, are inserted into the holes 60, and may extend beyond the junction piece 22 as shown to allow for the frame assembly to be secured to a further attachment component (not shown). Options for these connectors 61 include: screws, pegs, bolts, hooks, eyelets, etc.

FIG. 5-b shows a side elevation view of the butt joint detail incorporating the rigid connectors 61 as shown in FIG. 5-a.

FIG. 5-c shows a back elevation view of the butt joint detail incorporating the rigid connectors 61 as shown in FIG. 5-a.

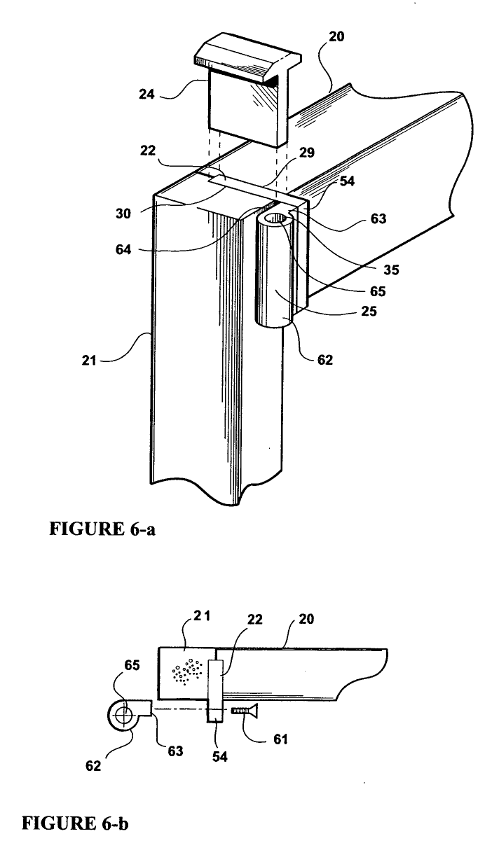

FIG. 6-a shows a perspective detail of a vibration welded corner butt joint that is similar to the vibration welded joint shown in FIG. 4 except that instead of the side edge extension 54 being attached to a fixed component, the side edge extension 54 is attachable to a hardware component 62 that forms part of an operable hardware system.

As shown in FIG. 6-a, the hardware component 62 incorporates a longitudinal cavity 35 for receiving an insert element (not shown). The hardware component 62 has a flat surface 64 adjacent to the thermoplastic member 21, a hollow cavity 35 and an attachment leg 63 that may in some embodiments allow the position of the pivoting point to be moved towards and/or away from the perimeter edge of the thermoplastic member 21. The operable hardware system may further include an insert element (not shown) such as a pivot pin or stem that is inserted into the cavity 35.

The hardware component 62 can be made from a variety of materials such as metal for reduced long term wear. Also if long term wear occurs, the hardware component 62 can be replaced if necessary unlike the component holder illustrated in FIG. 4-a. The hardware component 62 can also incorporate a range of features, including means for adjusting and fine-tuning the position of the pivoting point 65. A further possible feature is for the hardware component 62 to wrap-around both sides of the side edge extension 54 so as to allow for the hardware component 62 to be more firmly attached to the welding element 22 and thus to a frame assembly that is constructed using the illustrated joint structure.

FIG. 6-b shows a partially exploded plan view of a perspective butt joint detail shown in FIG. 6-a. The component 62 is attached to the side edge extension 54 by means of screws 61. The component leg 63 allows for the pivoting point 65 of the hardware component 62 to be offset from the junction piece 22.

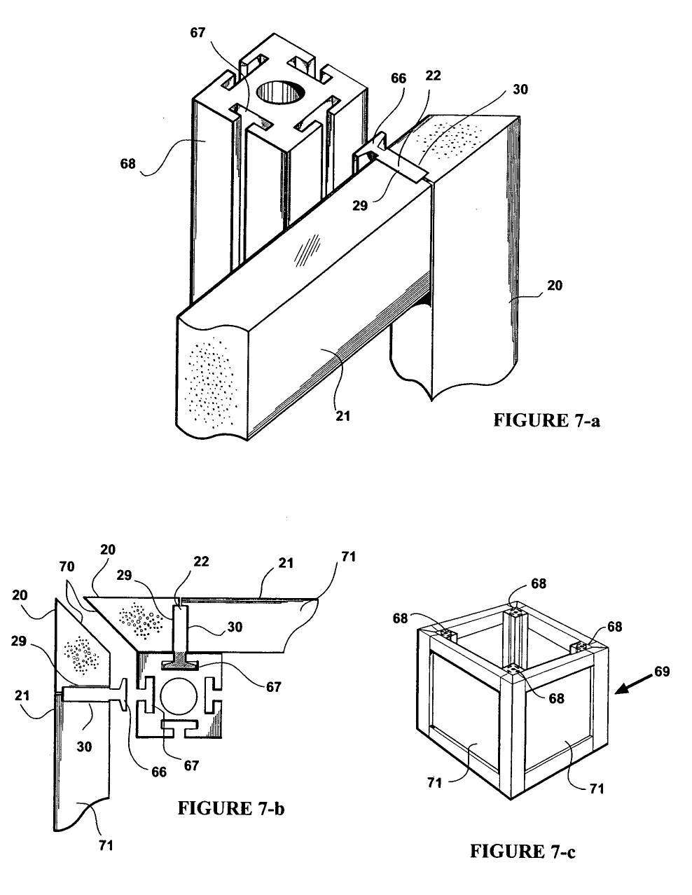

FIG. 7-a shows a perspective detail of a vibration welded corner butt joint that is similar to the vibration welded joint shown in FIG. 4-a except that instead of a side edge extension being fastened to a further attachment component by screws, the extension incorporates an integral longitudinal T-shaped end connector 66. The T-shaped end connector 66 allows a joint structure or frame assembly to be slid into a T-shaped recess. In one embodiment, a four-sided support column 68 incorporates a complementary T-shaped recess 67 on all four sides. The four-sided support column 68 can be fabricated from a variety of different materials including metal such as aluminum and/or plastic such as a composite material.

Although the end connector shown in FIG. 7-a is T-shaped, the connector can have a variety of different shapes including L-shaped or circular. The shape of the recess is similar or has the shape as the connector.

FIG. 7-b shows a partially exploded cross section plan detail of a box-panel assembly featuring corner butt-joints as shown in FIG. 7-a. The side profile edges 70 of the thermoplastic members 20 and 21 are miter cut or extruded with 45° cut-off angles. The frame panel assemblies 71 are slid into position on adjacent sides of the four-sided structural column 68 forming a longitudinal miter-cut corner joint that is not vibration welded.

FIG. 7-c shows a perspective view of a box panel 69 fabricated using miter cut corner joints 68 as shown in FIG. 7-b. Because of the robust construction of the miter cut corner joints 68, the box panel 69 can be easily disassembled and so this form of assembly is suitable for such applications as KD (knock down) shipping containers.

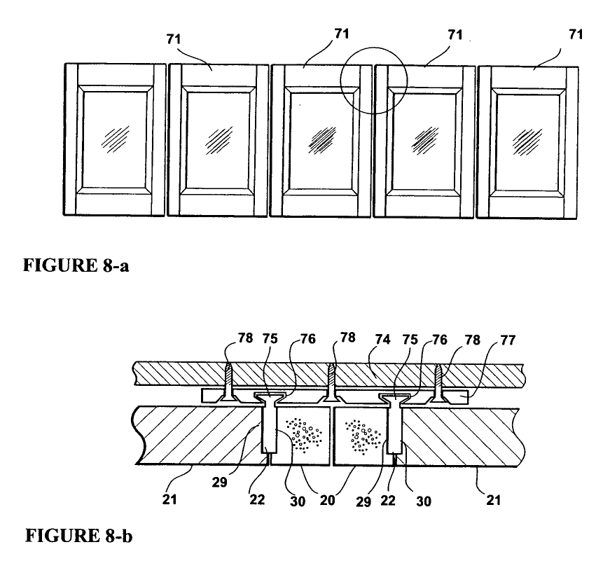

FIG. 8-a shows an elevation view of a framed panel wall assembly consisting of a series of panel assemblies 71 fabricated using vibratory welded butt corner joints similar to the welded joints shown in FIG. 7-a.

FIG. 8-b shows a horizontal cross section detail of two side-by-side frame panel assemblies 71 where the corners of the frame assembly are butt welded using a welding element 22 incorporating a side extension that is similar to the welding element described in FIG. 7-a with chamfered-cornered end connectors 75.

The framed panel assemblies 71 are slid into position and attached to a wall structure 74 by means of an intermediary support component 77 that incorporates complementary recesses 76 to the chamfered-cornered end connectors 75. Because of tolerance issues, the intermediary support 77 may be made from a semi-rigid or flexible material such as rubber. The intermediary support 77 is connected to the wall structure by means of fasteners 78.

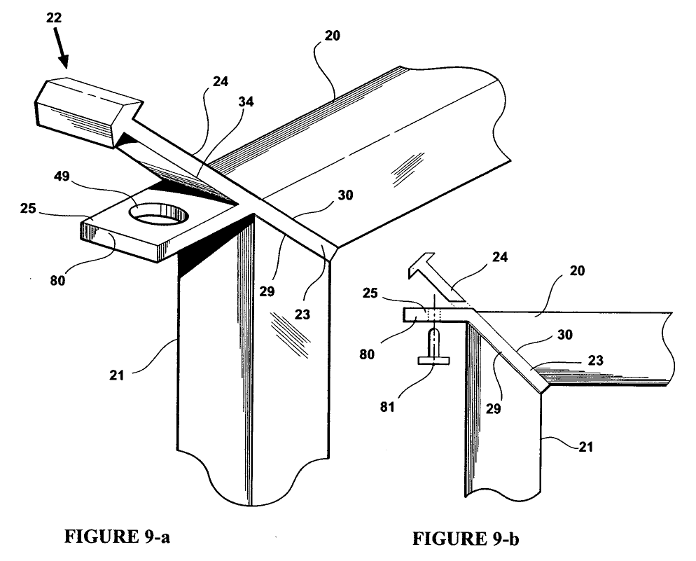

FIG. 9-a shows a perspective detail of a corner miter joint where the end faces of two thermoplastic members 20, 21 are vibration welded together using a separate welding element 22 and where the element 22 incorporates a further alternative configuration of the component holder 25. In this case, the component holder 25 includes a hole 49 that is incorporated in an angled extension 80 to the back edge 34 of the first portion 23 of the junction piece 22. Although at an obtuse angle to the first portion 23 of the welding element 22, the extension 80 is perpendicular to the framing member 21 in the embodiment shown. As a result, the hole 49 provides for a vertical pivot point support and allows for the insertion of various attachment components (not shown). The angled extension 80 is not necessarily a flat strip as shown in FIG. 9-a but can be a much larger element and can extend upwards or downwards as long as the larger extension 80 does not contact the thermoplastic member 21 during the vibration welding process.

FIG. 9-b shows a partially exploded elevation detail of the welded miter joint shown in FIG. 9-a. The second portion or tab 24 of the welding element 22 is removed so that there is no obstruction when the further attachment component 81 is inserted into the component holder 25.

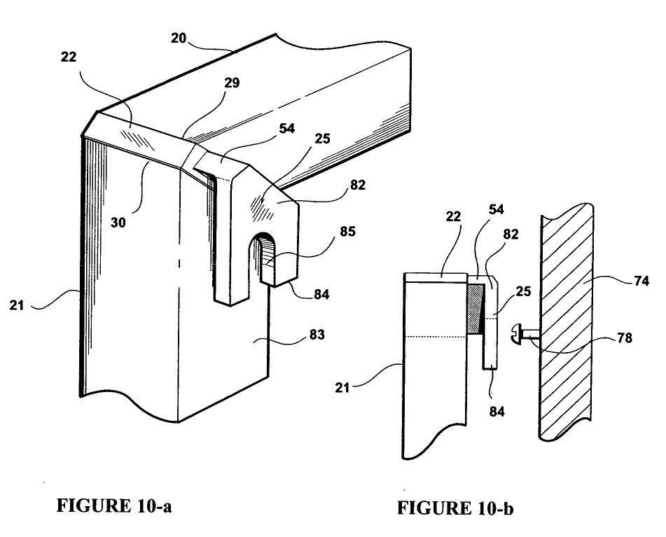

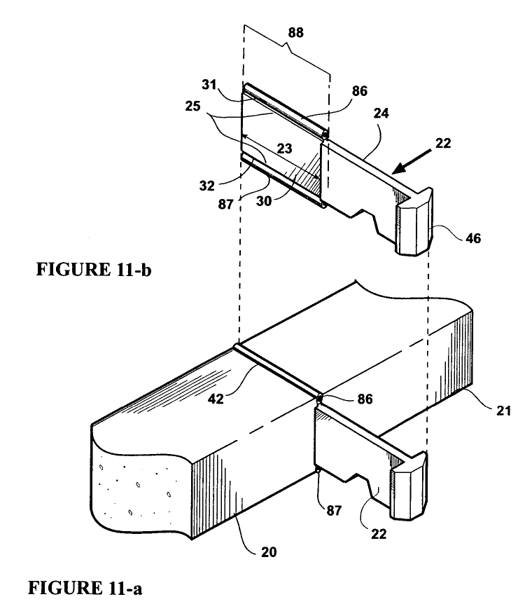

FIG. 10-a is a perspective detail of a corner miter joint where the end faces of two thermoplastic member 20, 21 are vibration welded together using a welding element 22 and where the welding element 22 incorporates a further alternative configuration of the component holder 25. In this case, the component holder 25 is a side edge extension 54 with a further perpendicular leg extension 82 parallel to a side surface 83 of the thermoplastic member 21 and where the bottom edge 84 of the leg extension 82 incorporates a vertical slot 85.

FIG. 10-b shows a partially exploded elevation corner detail of a panel assembly that is supported by means of screw connectors 78 attached to the wall structure 74. The screw connectors 78 slot into the component holder 25, as will be apparent from FIG. 10-b.

FIGS. 11-a and 11-b respectively show a perspective detail of a vibratory welding element 22 and a vibratory welded butt joint connection incorporating the welding element 22. The vibration welding butt joint in FIG. 11-a is similar to the vibration welded corner butt joint illustrated in FIG. 1-a except that the two end faces of the thermoplastic members 20 and 21 are butt joined together and there is also an alternative configuration of the component holder 25. In this case, there are two component holders 25 that are the inner and outer side edges 31 and 32 of the welding element 22. These two side edges 31 and 32 hold in position two flexible seal components 86 and 87 that are integrally formed and bonded to the welding element 22.

During the vibration welding process, because the seals are flexible, no friction heat is generated and the flexible seals 86 and 87 do not weld together. As a result, no weld flash is created and so this creates a clean aesthetic joint line 42.

In addition, the flexible seals 86 and 87 prevent moisture from entering the joint line 42. As previously noted, this is particularly useful for composite thermoplastic materials that can be damaged by moisture, such as wood fiber filled PVC materials.

FIG. 11 -b shows a perspective detail of the welding element 22 that is shown in FIG. 11-a and that includes first and second portions 23 and 24. The first portion 23 incorporates welding side surfaces 29 and 30 that are delineated by the dotted lines 88. The second portion 24 is a removable tab which incorporates a T-shaped end structure 46 that help holds the welding element 22 firmly in position during the vibration welding process.

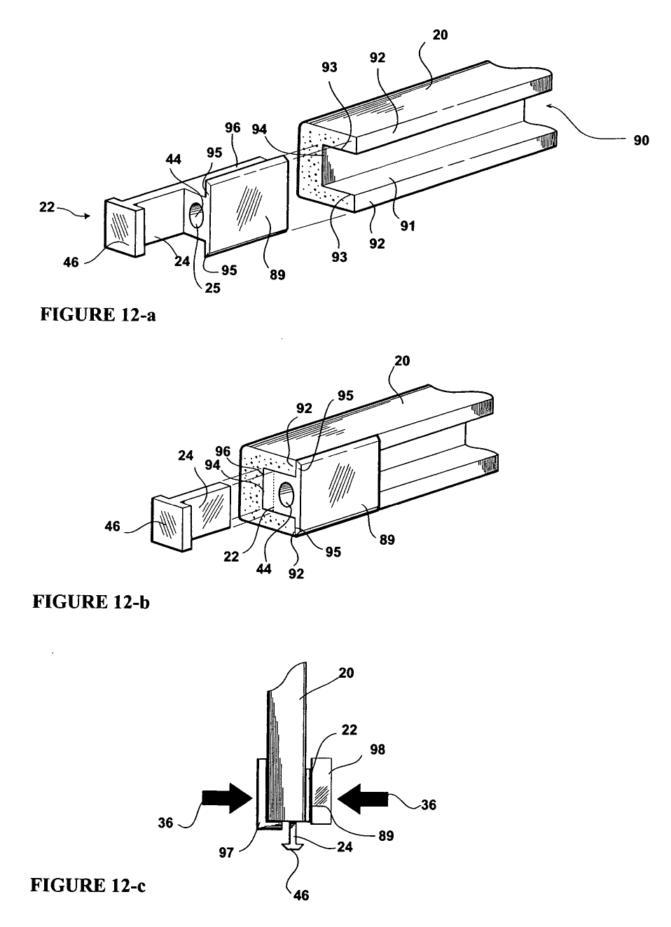

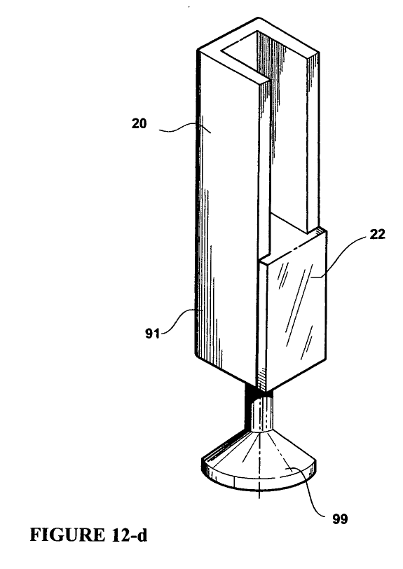

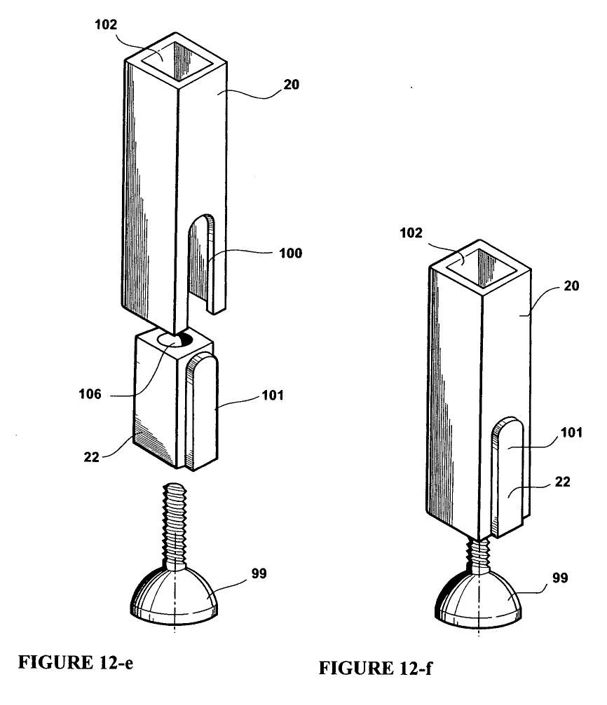

FIG. 12-a shows a perspective detail of a thermoplastic member 20 and a thermoplastic welding element 22 that is vibration welded to an end portion 91 of the thermoplastic member 20. The thermoplastic member 20 incorporates a U-channel 90 with top edge surfaces 92, side wall surfaces 93 and a bottom surface 94. The welding element 22 incorporates a component holder 25 which is similar to the component holder described in FIG. 1-a and includes a hollow cavity 44. The welding element 22 is shaped to give maximum contact to all surfaces that are parallel to the linear vibration movement and the element 22 features a bottom side surface 96 and a top flat plate 89 with extending side edges 95.

The top edge surfaces 92 and bottom surface 94 of the U-channel thermoplastic member 20 are vibration welded to the top plate side edges 95 and the bottom side surface 96 of the welding element 22. After the vibration welding process is complete, the tab 24 is removed and this allows for an adjustable leg component (not shown) to be attached without obstruction.

FIG. 12-b shows a perspective detail of a T-shaped thermoplastic welding element 22 described in FIG. 12-a which is vibration welded to an end portion 91 of the thermoplastic member 20.

FIG. 12-c shows a cross section of the vibration welded joint shown in FIG. 12-b. During the vibration welding process, the thermoplastic member 20 is held in position by a profile clamp 97 and the welding element 22 is held in position by means of an element clamp 98 that features a slippery inside surface finish.

During the vibration welding process, perpendicular pressure 36 is applied to the thermoplastic member 20 and to the top plate 89 of the welding element 22. The slippery surface of the element clamp 98 ensures that minimal friction heat is generated during the vibration welding process and so that there is no thermal bonding or surface damage of the top plate 89. After the vibration welding process has been completed, the tab 22 is removed.

FIG. 12-d shows a perspective detail of the adjustable leg component assembly with an adjustable leg support 99 inserted into the threaded hole cavity (not shown) of the welding element 22 that is vibration welded to the end portion 91 of the thermoplastic member 20.

FIG. 12-e shows an exploded perspective detail of an alternative adjustable leg component assembly. The hollow cavity welding element 22 is bonded to the back face 102 of the thermoplastic member 20, which is a hollow square profile extrusion. The thermoplastic profile 20 incorporates a fabricated bottom edge slot 100 and the welding element incorporates a complementary raised portion 101 that allows for pressure to be applied to the welding element 22 so that during the vibration welding process, the element 22 is forced against the back face 102 of the member 20. The raised portion 101 may also act as a stop against the bottom edge slot 100, thereby adding strength to support weight carried by the adjustable leg 99.

FIG. 12-f shows a perspective detail of the adjustable leg component assembly shown in 12-e. The adjustable leg 99 is inserted into the threaded hole cavity 106 of the welding element 22 that is welded to the back face 102 of the thermoplastic member 20.

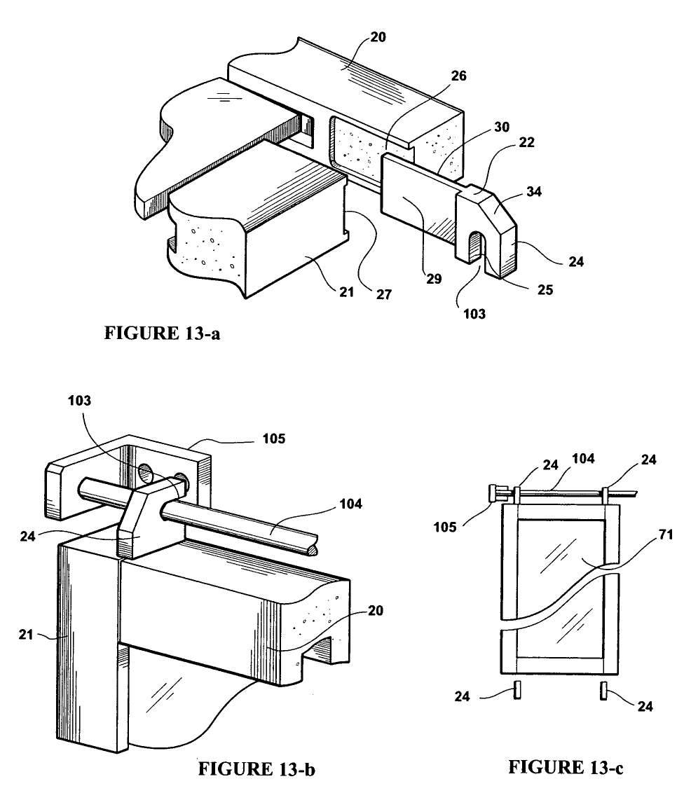

FIG. 13-a shows a partially exploded perspective detail of a vibration welded corner butt joint similar to the vibration welded joint shown in FIG. 1-a but with an alternative configuration of the component holder 25. In this case, the component holder 25 is the second portion 24 of the welding element 22, which incorporates a bottom edge slot 103. The bottom edge slot 103 allows for the welding element 22 to be clamped and held in position during the vibration welding process. As noted above, the second portion 24 of the welding element 22 may be removed following the vibration welding process but in this case, the second portion 24 remains in place and is used as an attachment device for a welded joint or frame assembly.

FIG. 13-b shows a perspective detail of the vibration welded butt joint corner that forms part of a frame assembly where the frame assembly is attached to a rod 104 that is inserted into a bottom edge slot 103 incorporated into the second portion 24 of the welding element 22. The rod 104 is held in position by means of a support bracket 105. Although the further component illustrated in FIG. 13-c is a rod, alternative attachment component options can also be used, including: static line, ring, hoop, etc.

FIG. 13-c shows an elevation view of a panel assembly 71 that incorporates joints as shown in FIGS. 13-a and 13-b. Since the panel assembly shown in FIG. 13-c is hung from the rod 104 at its top corners, the second portions 24 of the welding element 22 are removed at the two bottom corners of the panel assembly 71. However for the top two corners, the second portions 24 of the welding element 22 are not removed.

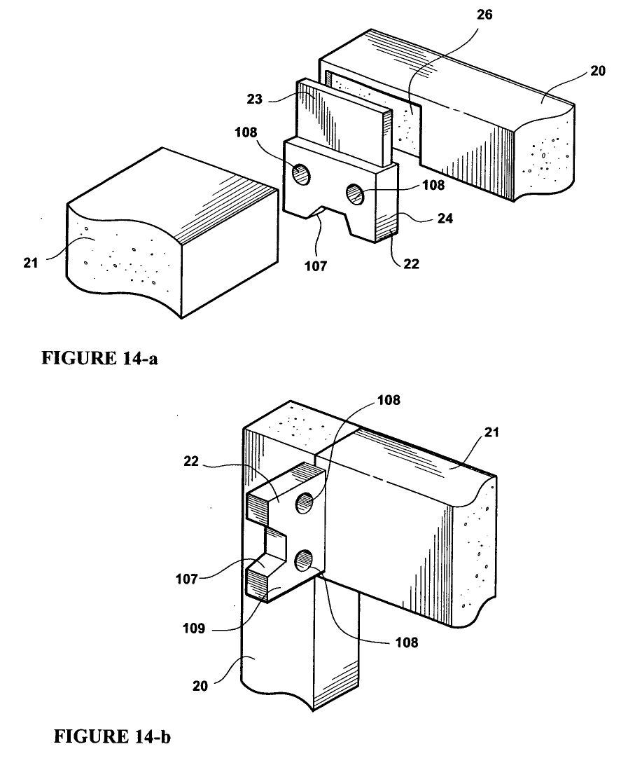

FIG. 14-a shows a partially exploded perspective detail of a vibration welded corner butt joint similar to the vibration welded joint shown in FIG. 13-a but with an alternative configuration of the welding element 22. Instead of the welding element 22 being held from the side, the welding element 22 is held from below during the vibration welding process. The second portion 24 of the welding element 22 incorporates a positioning slot 107 as well as clamping holes 108 to ensure that the welding element 22 is firmly held in position during the vibration welding process FIG. 14-b shows a perspective view of the vibration welded corner butt joint shown in exploded form in FIG. 14-a. The bottom-held second portion 109 of the welding element 22 is positioned vertically to support the frame assembly in position. The bottom-held, second portion 109 can either be attached through screw connections to a fixed support as shown in FIG. 4 or alternatively, the bottom held, second portion 109 can be attached through screw connections to a pivot hardware connector as shown in FIGS. 6-a and 6-b.

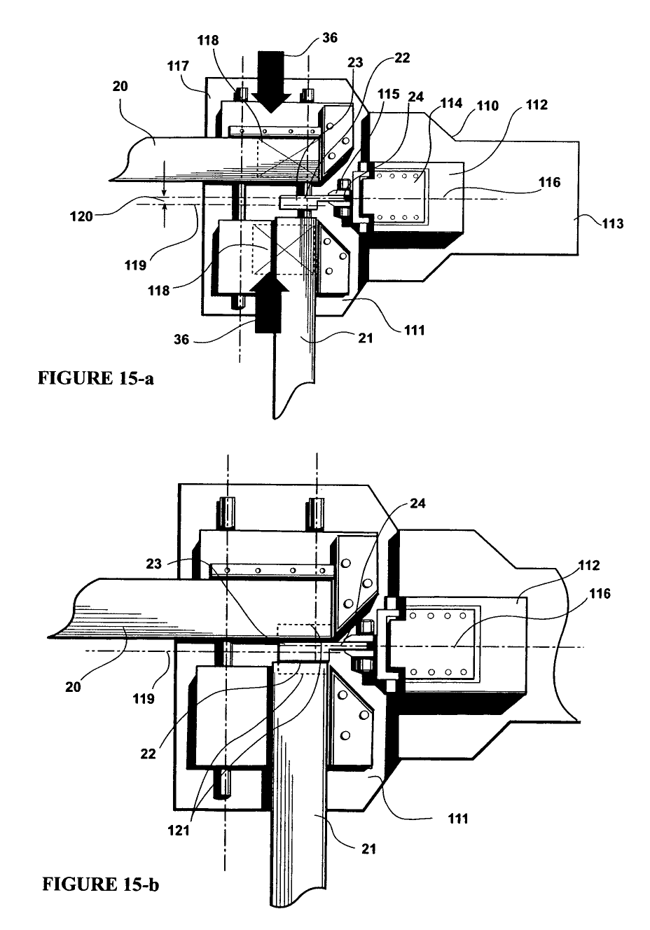

FIGS. 15-a and 15-b show plan views of one example of vibration welding equipment that can be used for manufacturing vibratory welded joints incorporating different types of component holders as previously described in FIGS. 1-14. Major elements of the vibratory welding equipment have been previously disclosed in Provisional U.S. Patent Application Ser. No. 60/800,007, filed on May 15, 2006, entitled “WELDED JOINT STRUCTURES FOR THERMOPLASTIC MEMBERS”, and incorporated in its entirety herein by reference. The vibratory welding equipment includes two major components 110 and 111.

The first major component 110 includes a vibratory head 112 and related support structure 113 including a vibratory plate 114 to which a tab clamp 115 is fastened. The tab clamp 115 holds the tab or second portion 24 of the welding element 22 firmly in position on a centre line datum 116. Because of various features that can be incorporated into the clamping tab 24, this centre line datum 116 may not be strictly the geometric center line of the tab 24 but is the geometric center line of the main body of the tab 24.

The second major component 111 includes the equipment structure 117 and two separate, independent clamping and positioning devices 118 that hold the thermoplastic members 20 and 21 in position. During the vibration welding process, substantially equal perpendicular pressure 36 is applied to the first portion 23 of the welding element 22 that is moved linearly back and forth.

Depending on the design elements incorporated into the first portion 23 of the welding element 22, a second predetermined datum line 119 is established. This predetermined datum line is the reference baseline for the various movement, positioning and profile pressuring operations that occur during the weld cycle. Specifically, the amount of movement for profile pressuring of the welding element 22 is determined from the predetermined datum line 119. In addition, the depth calculation for the amount of thermoplastic material to be melted during the weld cycle is also established equally from the predetermined datum line 119.

The position of the predetermined datum line 119 can vary depending on a number of factors, including: design of welding element including type of component holder 28, design of profile shape of thermoplastic members 20 and 21, type of thermoplastic material used, and the finished visual appearance of the corner joint or vibratory welded product.

FIG. 15-a shows the friction corner welder is an open position. The second portion or tab 24 of the welding element 22 is clamped in position on a centre line datum 116 and the predetermined datum line 119 for the first portion 23 is offset from the web centre line datum 116 by a distance 120. FIG. 15-b shows a plan view of the vibration welding equipment during the weld cycle. By using the dual datum line system, a wide variety of different types and sizes of welding elements can be used to form vibratory welded joints. The dotted lines 121 indicate the channel recesses 26 and 27 in the thermoplastic profiles 20 and 21.

What has been described is merely illustrative of the application of principles of embodiments of the invention. Other arrangements and methods can be implemented by those skilled in the art without departing from the scope of the present invention.

For example, references to parallel, perpendicular, vertical, end, side, front, back, and other orientations are intended solely for the purposes of illustration. A welding element, component holder, tab, etc. may be arranged relative to each other differently than explicitly shown in the drawings and described above.

### LIST OF REFERENCE NUMBERS

20. First thermoplastic member
21. Second thermoplastic member
22. Welding element or Junction piece
23. First portion of welding element
24. Second portion of welding element
25. Component holder
26. Channel recess for first member
27. Channel recess for second member
28. Further component
29. Side welding surface
30. Side welding surface
31. Inner side edge of first portion of welding element
32. Outer side edge of first portion of welding element
33. Front edge of first portion of welding element
34. Back edge of first portion of welding element
35. Longitudinal hollow cavity
36. Perpendicular pressure
37. Centering element
39. Cover
41. Pivot attachment
42. Thin butt joint line
43. Side extension
44. Hollow cavity
45. Tubular extension or hinge barrel
46. T-shaped end structure
48. Perpendicular back edge extension
49. Hole in back edge extension
50. Complementary hole
51. End face of thermoplastic member
52. Flexible foam
54. Side edge extension
55. Side face of side edge extension
56. Holes
57. Fasteners
58. Further attachment component
60. Perpendicular holes
61. Rigid connectors
62. Hardware component
63. Component leg
64. Flat surface
65. Pivoting point
66. T-shaped end connector
67. Complementary recesses
68. Four sided column
69. Box panel assembly
70. Side edge
71. Panel assembly
74. Wall Structure
75. T-shaped end connector with chamfered corners
76. Complementary recesses
77. Intermediary support
78. Fasteners
80. Inclined angle extension
81. Further attachment component
82. Leg extension
83. Side surface
84. Bottom edge
85. Vertical slot
86. Flexible seal
87. Flexible seal
88. Dofted lines
89. Top plate
90. U-channel
91. End portion of thermoplastic member
92. Top edge surface of U-channel
93. Side wall surface of U-channel
94. Bottom surface of U-channel
95. Side edges of T-shaped element
96. Bottom surface of T-shaped element
97. Profile clamp
98. Element clamp
99. Adjustable leg support
100. Bottom edge slot
101. Raised portion of welding element
102. Back face of profile
103. Bottom edge slot
104. Rod
105. Support bracket
106. Threaded hole cavity
107. Positioning slot
108. Clamping holes
109. Bottom held, second portion
110. First major component—vibratory head and related support structure
111. Second major component—clamping and holding means
112. Vibratory head
113. Support structure
114. Vibratory plate
115. Tab clamp
116. Centre line datum—welding tab
117. Equipment structure
118. Profile clamp
119. Predetermined datum—welding portion
120. Offset distance
121. Dotted lines

We claim:

1. A vibration welding element composed at least in part of a thermoplastic material, said element comprising:
a welding surface for forming a vibratory welded bond between said element and a thermoplastic member; and
a component holder, physically coupled to said welding surface, for enabling said element to hold a further component.

2. The vibration welding element of claim 1, wherein said component holder comprises a tab that further enables said element to be held in a fixture of a vibratory head during a vibratory welding process by which said vibratory welded bond is formed.

3. The vibration welding element of claim 1, wherein said component holder comprises a cavity, defined at least partially by said welding surface, for receiving at least a portion of said further component.

4. The vibration welding element of claim 1, wherein said component holder comprises a structure for receiving a fastener, said structure allowing said further component to be secured to said element by a fastener inserted into said structure.

5. The vibration welding element of claim 1, wherein said further component is integrated with said element, said component holder comprising a portion of said element connecting said welding surface with said further component.

6. The vibration welding element of claim 1, wherein said component holder is integrated with an extension of said element beyond said welding surface.

7. The vibration welding element of claim 6, wherein said extension comprises, as said component holder, at least one of:
a cavity for receiving at least a portion of said further component; and
a structure for receiving a fastener, said structure allowing said further component to be secured to said element by a fastener inserted into said structure.

8. The vibration welding element of claim 6, wherein said extension is at an angle to said welding surface.

9. The vibration welding element of claim 6, wherein said extension extends in a direction parallel to said welding surface and comprises an end structure, and wherein said further component comprises a structural support incorporating at least one opening having a shape complementary to said end structure, said end structure enabling said element and said member to be supported by said structural support.

10. The vibration welding element of claim 9, wherein said end structure further enables said element to be held in a fixture of a vibratory head during a vibratory welding process by which said vibratory welded bond is formed.

11. The vibration welding element of claim 9, wherein said structural support comprises a multi-sided structural support, a plurality of sides of said structural support incorporating respective openings having a shape complementary to said end structure.

12. The vibration welding element of claim 9, wherein said structural support comprises a connector incorporating at least two adjacent, spaced openings having a shape complementary to said end structure.

13. The vibration welding element of claim 6, wherein said extension is substantially perpendicular to said welding surface, and wherein said extension has substantially the same cross sectional shape as said thermoplastic member, and wherein said component holder comprises means for attaching said further component.

14. The vibration welding element of claim 13, wherein said means for attaching said further component comprises a hole.

15. The vibration welding element of claim 14, wherein said means for attaching said further component comprises a protrusion.

16. The vibration welding element of claim 1, wherein said component holder comprises one or more edges of said welding element, and wherein said further component comprises a flexible rubber seal.

17. The vibration welding element of claim 1, wherein said component comprises at least one of:
a fixed structural support;
a component of a movable hardware arrangement;
a compressible seal; and
an adjustable leg.

18. A joint structure comprising:
first and second thermoplastic members; and
an interposed junction piece comprising welding surfaces respectively vibratory welded to said first member and to said second member, and a component holder, physically coupled to said welding surfaces, for enabling said joint structure to hold a further component.

19. The joint structure of claim 18, wherein said welding surfaces are parallel to each other, wherein said component holder comprises an extension of said junction piece perpendicular to the welding surfaces, and wherein said interposed junction piece forms a butt joint between said members.

20. The joint structure of claim 18, wherein said welding surfaces are parallel to each other, wherein said interposed junction piece forms a miter joint between said members, and wherein said component holder comprises an extension of said interposed junction piece at an angle to said welding surfaces and perpendicular to one of said members.

21. The joint structure of claim 20, wherein said extension incorporates a connector.

22. The joint structure of claim 21, wherein said connector comprises a plate having a preformed hole therein.

23. The joint structure of claim 18, wherein said component holder comprises an extension of said interposed junction piece beyond said welding surfaces, said extension spacing a connector from one of said members and positioning said connector parallel to a longitudinal length of said one of said members.

24. The joint structure of claim 23, wherein said connector is an open-ended slot connector.

25. The joint structure of claim 18, wherein said component comprises at least one compressible seal for sealing a gap between said first and second members.

26. An assembly incorporating a plurality of welded joint structures as claimed in claim 18.

27. A method for forming a vibratory welded connection between a welding element and a structural member, where said member and said junction piece are composed at least in part of thermoplastic material, said method comprising:
providing a welding element having a welding portion for welding to said member, and a component holder, physically coupled to said welding portion, for enabling said element to hold a further component;
creating an engagement force between said member and said welding portion; and
maintaining said engagement force while vibrating said welding element to create friction generated heat to melt material on said welding portion and said member, such melted material upon cooling forming a weld between said welding element and said member.

28. The method of claim 27, wherein vibrating comprises:
mounting said component holder to a fixture connected to a vibratory head; and
vibrating said welding element by means of said vibratory head.

29. The method of claim 27, further comprising:
installing said further component at said component holder.

30. The method of claim 27, wherein said welding element comprises a removable tab that is held in a fixture during vibration of the welding element, and wherein said welding portion is offset from said removable tab.
